(19) United States
(12) Patent Application Publication
(10) Pub. No.: US 2025/0322752 A1
(43) Pub. Date: Oct. 16, 2025

(54) METHOD OF MONITORING A TRAFFIC AREA WITH A TRAFFIC MONITORING SYSTEM AND TRAFFIC MONITORING SYSTEM

(71) Applicant: Continental Automotive Technologies GmbH, Hannover (DE)

(72) Inventors: Robert Allen Gee, Lake Barrington, IL (US); Marc Menzel, Weimar (Lahn) (DE); Ulrich Stählin, Eschborn (DE)

(73) Assignee: Continental Automotive Technologies GmbH, Hannover (DE)

(21) Appl. No.: 19/176,368

(22) Filed: Apr. 11, 2025

(30) Foreign Application Priority Data
Apr. 15, 2024 (DE) 10 2024 203 442.8

(51) Int. Cl. G08G 1/16; G08G 1/01; G08G 1/052; G08G 1/056

(52) U.S. Cl. CPC G08G 1/164; G08G 1/0108; G08G 1/0141; G08G 1/0145; G08G 1/052; G08G 1/056; G08G 1/166

(57) ABSTRACT

A traffic monitoring system has at least one environment sensor and a communication device for sending and receiving traffic messages from road users, which may contain status information of the road user or information from the sensors of the road user. The road user is determined with the environment sensor and a traffic map of the traffic area including the determined road users is created. Road users who can send or receive traffic messages are determined and compared with the traffic map. It is determined what kind of traffic messages road users can receive and send. If a critical situation could arise between at least two road users and if at least one of these road users can receive traffic messages, a traffic message is sent to the road user able to receive traffic messages containing information about a road user who cannot send or receive traffic messages.

### BRIEF DESCRIPTION OF THE DRAWINGS

Embodiments are explained in more detail with reference to the enclosed figures, in which:

FIG. 1 shows a first exemplary embodiment according to a traffic situation on a road with oncoming traffic,

FIG. 2 shows a second exemplary embodiment according to a traffic situation in an intersection area, and

FIG. 3 shows a third exemplary embodiment according to a traffic situation, also in an intersection area.

### DETAILED DESCRIPTION

The disclosure relates to a method for monitoring a traffic area with a traffic monitoring system, which has at least one environment sensor and a communication device for sending and receiving traffic messages from road users. The disclosure relates further to such a traffic monitoring system.

In the prior art, traffic monitoring methods are known in which road users can communicate with other road users and/or a traffic monitoring system via standardized traffic messages. The traffic messages may include information about the respective road user, wherein this information may include, for example, the position, speed and/or a planned route of the road user within the traffic area. This type of traffic message is also known as a Basic Safety Message (BSM). In addition, such traffic messages may also contain additional information, such as information from vehicle sensors that record the road user's surroundings. Such traffic messages may, for example, be referred to as a Collective Perception Message (CPM).

Other road users can use these traffic messages to adjust their own behavior within the traffic area, for example to avoid collisions. A traffic monitoring system can also adapt the control of a traffic control system of the traffic area on the basis of these traffic messages and warn or guide individual road users in order to avoid collisions with other road users.

A basic problem is that not all road users are able to send and/or receive traffic messages. For example, older vehicles may not have the appropriate communication equipment to send and/or receive such traffic messages. Furthermore, pedestrians or cyclists may not have the appropriate communication equipment.

In addition, it may happen that not all road users are able to send and/or receive a basic safety message and/or a collective perception message. However, an approach in which information, for example from a traffic monitoring system, is sent to all road users in the traffic area would lead to a very high level of data traffic within the traffic area.

It is an object of the disclosure to provide a method for monitoring a traffic area as well as a traffic monitoring system, which enable improved safety within the traffic area, for example even with road users with different communication options, wherein data traffic within the traffic area is to be reduced.

The object is solved by the subject matter of the independent claims. Embodiments are described in the dependent claims.

To solve the object, a method for monitoring a traffic area with a traffic monitoring system is provided, wherein the traffic monitoring system has at least one environment sensor and a communication device for sending and receiving traffic messages from road users. The traffic messages may contain status information of the road user and/or information from the road user's sensors. The method comprises the following steps:
a) Determining of road users within the traffic area with at least one environment sensor and creation of a traffic map of the traffic area that includes the determined road users,
b) Determining road users who can send and/or receive traffic messages and receiving traffic messages from these road users,
c) Comparison of the determined road users who can send and/or receive traffic messages with the traffic map of the traffic area and determining the road users in the traffic map who can send and/or receive traffic messages.
In addition, the following steps are carried out:
d) Checking whether a critical situation could arise between road users within the traffic area,
e) If a critical situation could arise between at least two road users, checking whether at least one of these road users can send and/or receive traffic messages, and
f) If at least one of these road users can send and/or receive traffic messages, sending a traffic message to that road user, the traffic message or traffic messages containing information about the at least one road user who cannot send and/or receive traffic messages.

The basic idea of the disclosure is to check whether it is necessary to send an additional traffic message before sending messages, for example to avoid a critical situation. A critical situation can be that road users come too close to each other and there is a risk of collision or contact between road users. In addition, other critical situations can be defined, which lead to a delay for other road users, for example. If such a message is detected, it is checked which road users can receive traffic messages, wherein only one traffic message is sent, since at least one road user can receive such a traffic message. This can significantly increase safety within the traffic area, as the traffic messages can better warn road users who can receive such traffic messages of critical situations. Furthermore, data traffic within the traffic area is significantly reduced, as traffic messages are only sent if they can be received by at least one road user.

In addition, there may be the following step, which may, for example, be performed before step d) as mentioned above and/or after step c) as mentioned above:
Determining what kind of traffic messages road users can receive and send.

This step may help with optimizing communication. For example, it can be implemented that only traffic messages which a road user can receive are sent to this road user, and/or that one listens only to traffic messages from a road user which this road user can send. Especially, sending of specific types of traffic messages can be omitted if there is no road user being able to receive them. Types of traffic messages can, for example, be a basic safety message (BSM) and a collective perception message (CPM).

For example, determining whether road users can send and/or receive traffic messages can be done by receiving traffic messages from road users. Road users who can send and/or receive traffic messages usually send out such traffic messages on a regular basis. So if a traffic message is received, it can be assumed that this road user can also receive traffic messages himself. This makes it easy to check whether and which road users can receive traffic messages.

In particular, the detection, recording, or determining of road users who can send and/or receive traffic messages may include an examination of whether road users can send and/or receive basic safety messages, which include the position and movement information of the road user, and/or collective perception messages, which additionally include information from the vehicle's sensors, wherein the sending of the traffic message to at least one road user depending on this examination. Especially, it can be implemented that basic safety messages are only sent if there is a road user which can receive them. Especially, it can be implemented that collective perception messages are only sent if there is a road user which can receive them. It can also be implemented that traffic messages are only sent if there is at least one road user not being able to send traffic messages. Thus, other road users can be informed about this road user by such messages.

The determining of road users within the traffic area can, for example, be performed using received messages and/or environmental sensors. The traffic map can be implemented as an electronic map. Determining the road users who can send and/or receive traffic messages can be performed by receiving messages and/or by sending specific requests, e.g. pings, to such road users. A critical situation can especially be determined by predicting paths or other behavior of the road users. For example, one can check if such predicted paths overlap such that a collision can occur. For this purpose, the map can be used.

The method described herein is especially intended to help external road users with avoiding collisions or handling critical situations among them. A road user performing the method and sending a traffic message as described in response to a detected critical situation may be not part of the critical situation. Alternatively, a road user performing the method can also be part of the critical situation. Also such implementations are possible.

Basically, the vehicles can send and/or receive different types of traffic messages. For example, a road user may periodically send a basic safety message that contains basic status information about the road user, such as their position, speed, and/or a planned movement path. This basic safety message is made available to all road users within the traffic area. It can therefore be assumed that all road users who can receive and/or send traffic messages can also receive this basic safety message.

In addition, road users can send collective perception messages, which, in addition or alternatively to the information contained in the basic safety message, include other information that road users can collect, for example with additional sensors. For example, the road user can collect information about his own environment, such as other road users who are in the immediate vicinity of the road user. If a road user sends out such a collective perception message, it can be assumed, for example, that this road user is aware of his surroundings. Furthermore, it can be assumed that this road user can receive and process any or such kind of traffic message, in particular a collective perception message.

The information on what kind of traffic messages the road users can receive and send, in particular the information on what information is available to the road users themselves or what information is already shared with other road users, can be taken into account when deciding what information is sent or provided by the traffic monitoring system in order to further reduce data traffic. For example, if all road users within the traffic area can send and receive traffic messages, it can be assumed that road users are already provided with extensive information via the traffic information sent out by road users, which does not have to be additionally sent or provided by the traffic monitoring system.

If, on the other hand, at least one road user is determined who cannot send and/or receive traffic messages, it should be checked whether the other road users need to receive information about this road user, for example in order to avoid a critical situation. If this is the case, it is preferable to check whether the other road users already receive information about this road user and, if not, to ensure that the other road users receive this information.

On the one hand, it is preferable to ensure that road users are provided with all the information they need, either via traffic messages sent by the road users themselves or through traffic messages provided and sent by the traffic monitoring system. Furthermore, it is preferable to ensure that information is not sent multiple times in order to keep data traffic as low as possible.

If the determining of road users who can send and/or receive traffic messages shows that at least one road user cannot send or receive, or at least cannot send, a traffic message, a traffic message with information about at least one road user can be created and sent, for example.

For example, a basic safety message can be created on behalf of this road user, which provides the other road users with basic information about this road user.

In particular, it can be checked whether at least one road user can send and/or receive a basic safety message and the traffic monitoring system only creates and sends a basic safety message with information about the at least one road user, who cannot send and/or receive traffic messages, if at least one road user can send and/or receive a basic safety message.

If at least one vehicle can send and/or receive a collective perception message, a collective perception message can also be created and sent, in which, for example, information on several road users is summarized.

Depending on whether both road users who can only send and/or receive a basic safety message and road users who can send and/or receive a collective perception message have been detected, both a basic safety message and a collective perception message can also be sent, but if only the sending/receiving of a collective perception message or a basic safety message is possible, then only the message will be sent that can be sent and/or received.

Furthermore, it is possible that the collective perception message contains only information about road users who cannot send and/or receive a traffic message. This enables quick identification of such road users.

In certain embodiments, the collective perception message only contains information about road users for whom no basic safety message has been created and sent.

It is also possible that the determining of road users includes the detection of a position as well as movement information, in particular the detection of the direction of movement, speed and/or a steering angle.

In advantageous embodiments, it can be checked after receiving the traffic messages whether the traffic messages contain information on road users that were not determined by the environment sensors, and the traffic map may be supplemented with this information. This is advantageous when optimizing the traffic map.

In addition to the previously discussed method, the system described below also solves the problem, namely a traffic monitoring system for a traffic area with at least one environment sensor for determining the traffic area and the road users in the traffic area as well as a communication device for sending and receiving traffic messages from road users, wherein the traffic messages may have status information of the road user and/or information from the road user's sensors, wherein the traffic monitoring system is designed to carry out a method as disclosed herein.

In embodiments, it may be provided that the environment sensor and/or the communication device are installed stationary in and/or on the traffic area.

In embodiments, it may be provided that the environment sensor and/or the communication device are mobile, in particular installed on a vehicle and/or a road user.

Embodiments may require that the environment sensor has an optical, acoustic and/or electromagnetic sensor, in particular a camera, a radar and/or a LIDAR sensor.

The term “send and/or receive” generally denotes the options “send”, “receive”, and “send and receive”. Corresponding replacements can be made. The same is true for similar terms.

In the following detailed description reference is made to the accompanying drawings, which form part of this document and which, for illustration, show specific embodiments which may be carried out. It is understood that other embodiments can also be used and structural or logical changes can be made without deviating from the concept of the present disclosure. The following detailed description is therefore not to be understood in a restrictive sense. It is also understood that the characteristics of the various embodiments described herein may be combined with each other, unless specifically stated otherwise.

The aspects and embodiments are described by reference to the drawings, with identical reference signs generally referring to the same elements. In the following description, numerous specific details are set out for explanatory purposes in order to provide an in-depth understanding of one or more aspects of the disclosure. However, it may be obvious to a skilled person that one or more aspects or embodiments can be carried out with a lower degree of specific detail. In other cases, known structures and elements are presented in schematic form to facilitate the description of one or more aspects or embodiments. It is understood that other embodiments can be used and structural or logical changes can be made without deviating from the concept of the present disclosure.

In addition, although a particular feature or aspect of an embodiment may have been disclosed in respect of only one of several implementations, such a feature or aspect may be combined with one or more other features or aspects of the other implementations as may be desirable and advantageous for a given or particular application. Furthermore, to the extent that the expressions “contain”, “have”, “with” or other variants thereof are used either in the detailed description or in the claims, such expressions should be inclusive in a manner similar to the expression “include”. The expressions “coupled” and “connected” may have been used together with derivatives of them. It is understood that such expressions are used to indicate that two elements cooperate or interact with each other regardless of whether they are in direct physical or electrical contact or are not in direct contact with each other. Moreover, the term “exemplary” is to be understood merely as an example rather than as a designation for the best or optimal. The following description is therefore not to be understood in a restrictive sense.

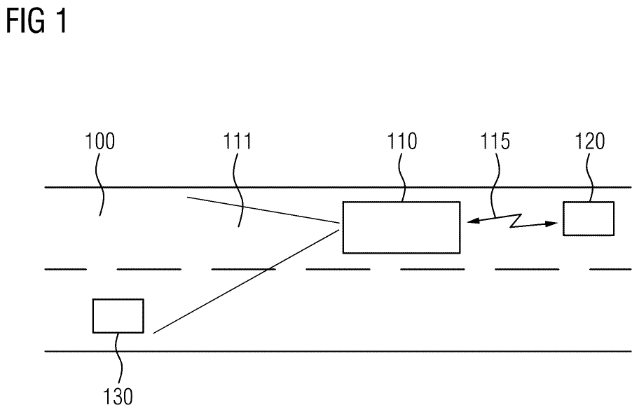

FIG. 1 shows a representation of an embodiment of the present disclosure as it can be designed in a traffic situation on a road 100. On road 100 there are three road users 110, 120 and 130, wherein the first road user 110 can be a truck, but this can also be a car or another road user. Furthermore, behind the first road user 110 there is a second road user 120 with the same direction of travel as the first road user 110. The second road user 120 can be a passenger car, but this can also be another road user such as a truck, van, or motorcycle. The second road user approaches the first road user 110, and in this exemplary embodiment there is the possibility that the second road user 120 wants to overtake the first road user 110 due to the latter's lower speed. Furthermore, there is a third road user 130 in the opposite lane. Since the size of the first road user 110 restricts the view for the second road user 120, a dangerous traffic situation may exist here as soon as the second road user 120 initiates the overtaking maneuver and has to drive into the oncoming lane for this purpose. The first road user has a sensor, the sensor has a detection area 111. The sensor is used to detect an area in front of the first road user 110, and can, for example, detect vehicles that are in the detection area 111 of the sensor. There is a wireless connection 115 between the first road user 110 and the second road user 120.

In this exemplary design, the first road user 110 has both BSM and CPM communication capabilities. The second vehicle, 120, either has the ability to communicate via CPM or only has the ability to communicate via BSM. In any case, the third vehicle 130 does not have V2X communication capabilities.

In the first case, the sequence is as follows: the first vehicle 110 detects in the detection area 111 of the sensor that the third vehicle 130 is approaching. Likewise, the first vehicle 110 detects that there are other V2X-capable vehicles in the area, in particular it detects that a vehicle that supports CPM is in the area, furthermore, the first vehicle 110 has detected that the third vehicle 130 does not have V2X capabilities. Since the first vehicle has determined that the second vehicle 120 is behind it and the approaching third vehicle 130 is in the opposite lane, the first vehicle 110 decides to send data about the third, non-V2X-capable vehicle 130 to vehicles in the vicinity using CPM. After the second vehicle 120 receives the CPM message, the second vehicle 120 generates a warning for its driver. This warning can be an overtaking warning DNPW (Do Not Pass Warning), which warns the driver of an overtaking maneuver in order to avoid a head-on collision between the second vehicle 120 and the third vehicle 130.

In the second case, the sequence is as follows: the first vehicle 110 detects in the detection area 111 of the sensor that the third vehicle 130 is approaching. Likewise, the first vehicle 110 detects that there are other V2X-capable vehicles in the vicinity, in particular that a vehicle that only supports BSM is in the vicinity, and furthermore, the first vehicle 110 has detected that the third vehicle 130 does not have V2X capabilities. Since the first vehicle has determined that the second vehicle 120 is behind it and the approaching third vehicle 130 is in the opposite lane, the first vehicle 110 decides that data about the third, non-V2X-capable vehicle 130 will be sent to vehicles in the vicinity by means of a BSM message. After the second vehicle 120 has received the BSM message, the second vehicle 120 generates a warning for its driver. This warning can be an overtaking warning DNPW (Do Not Pass Warning), which warns the driver of an overtaking maneuver in order to avoid a head-on collision between the second vehicle 120 and the third vehicle 130.

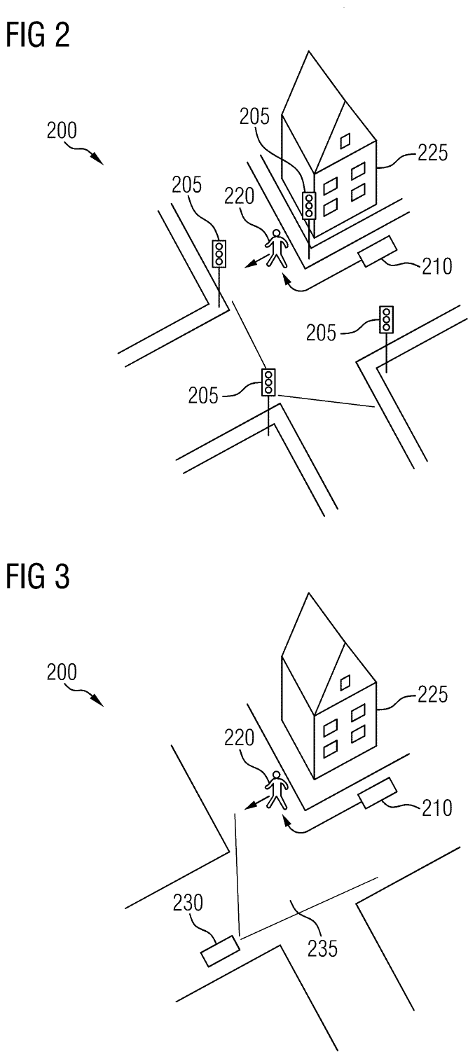

FIG. 2 shows an intersection area 200 equipped with traffic light systems 205. A vehicle 210 enters the intersection area to turn right at the intersection. A pedestrian 220, a so-called vulnerable road user (VRU), crosses the road in the area of intersection area 200. For the vehicle 210, a building 225 blocks the view in the direction in which vehicle 210 wants to turn. Therefore, it is not possible for the vehicle 210 to recognize the pedestrian 220 in time, i.e. before the vehicle 210 has turned. The traffic light systems 205 are each equipped with sensors that enable the traffic light systems 205 to detect road users in the intersection area 200. Due to the existing sensor technology, such an intersection area 200 is also referred to as a smart intersection.

Similar to the previous example, which was explained in FIG. 1, the sensors of the traffic light systems 205 detect both the approaching vehicle 210 and the pedestrian 220, as well as the fact that the pedestrian 220 does not have V2X capabilities. In addition, the traffic light system 205 is able to detect that vehicle 210 has V2X capabilities, and that vehicle 210 can handle CPM notifications in a first case and only BSM notifications in another second case. In the scenario presented here, which is only an example, the traffic light system 205 indicates to vehicle 210 by means of a green light that it is allowed to turn, and the driver of vehicle 210 will assume that there are no obstacles in the street into which he is turning due to the green light. However, the pedestrian 220 crosses the street into which vehicle 210 turns, although he is not shown a green light. Due to the existing sensors, the traffic light system 205 is able to detect that pedestrian 220 is crossing the road without authorization, at the same time the vehicle 210 is turning into the road and thus a dangerous situation exists in which the pedestrian 220 could be injured. The traffic light system 205 therefore sends a message to the vehicle 210 so that the vehicle can display a warning to the driver that warns the driver of the unexpected obstacle. In an embodiment, this message can be a CPM message because the traffic light system 205 has previously detected that vehicle 210 is capable of receiving and processing CPM messages. In an alternative embodiment, this message may be a BSM message because the traffic light system 205 has previously detected that vehicle 210 is capable of receiving and processing only BSM messages.

FIG. 3 shows an intersection area 200, which is similar to the intersection area 200 described in FIG. 2, but this intersection area does not have a traffic light system equipped with sensors. A vehicle 210 enters the intersection area to turn right at the intersection. A pedestrian 220, a so-called vulnerable road user (VRU), crosses the road in the area of intersection 200. For the vehicle 210, a building 225 blocks the view in the direction in which vehicle 210 wants to turn. Therefore, it is not possible for vehicle 210 to recognize the pedestrian 220 in time, i.e. before vehicle 210 has turned. In contrast to the scenario described in FIG. 2, in FIG. 3 there is a second vehicle 230 in the intersection area, this vehicle is equipped with sensors, wherein the sensors have a detection area 235; in comparison with FIG. 2, the vehicle 230 with its sensors takes the place of the sensor-equipped traffic light system 205 as described in FIG. 2. As described above, the second vehicle 230 uses its sensors to detect the road users in the detection area 235, namely the first vehicle 210 and the pedestrian 220. In addition, as previously described, the vehicle 230 determined that the vehicle 210 has V2X capabilities, but the pedestrian 220 does not have such capabilities. The vehicle 230 now sends a message to the vehicle 210 to inform it of the presence of pedestrian 220. In an embodiment, this message may be a CPM message because the vehicle 230 has previously detected that the vehicle 210 is capable of receiving and processing CPM messages. In an alternative embodiment, this message may be a BSM message because the vehicle 230 has previously recognized that vehicle 210 is capable of receiving and processing only BSM messages.

The vehicles described above have been described as passenger cars or trucks without limitation of the generality, but it is clear that such vehicles are not necessarily limited to such vehicles, but can be any motor vehicle, in particular multi-track motor vehicles such as passenger cars (cars) or trucks, or even single-track vehicles such as motorcycles. These vehicles can be equipped for autonomous or highly automated driving. The road user described can be a Vulnerable Road User (VRU) such as a pedestrian, a bicycle or a motorcycle, but the road user can also be another vehicle, such as an e-bike or an e-scooter.

In general, it should be noted that vehicle-to-X (V2X) communication is understood in particular as direct communication between vehicles and/or between vehicles and infrastructure facilities. For example, it can be vehicle-to-vehicle communication or vehicle-to-infrastructure communication. If reference is made to communication between vehicles in the context of this application, this can in principle take place, for example, in the context of vehicle-to-vehicle communication, which typically takes place without intermediation by a mobile phone network or similar external infrastructure and which is therefore distinguished from other solutions based on a mobile network, for example. For example, vehicle-to-X communication can be done using the IEEE 802.11p or IEEE 1609.4 standards. Vehicle-to-X communication can also be referred to as C2X communication. The sub-areas can be referred to as C2C (Car-to-Car) or C2I (Car-to-Infrastructure). However, the disclosure does not explicitly exclude vehicle-to-X communication with transmission, for example via a mobile phone network. Vehicle-to-vehicle communication can also take place via UMTS or LTE, for example.

1. A method for monitoring a traffic area with a traffic monitoring system which has at least one environment sensor and a communication device for sending and receiving traffic messages from road users, wherein the traffic messages may contain status information of the road user or information from road user's sensors, comprising:
determining of road users within the traffic area with at least one environment sensor and creation of a traffic map of the traffic area that includes the determined road users,
determining road users who can send or receive traffic messages and receiving traffic messages from these road users,
comparing the determined road users who can send or receive traffic messages with the traffic map of the traffic area and determining the road users in the traffic map who can send or receive traffic messages, and
checking whether a critical situation could arise between road users within the traffic area,
if a critical situation could arise between at least two road users:
checking whether at least one of the at least two road users can send or receive traffic messages, and
if at least one of the at least two road users can send or receive traffic messages:
sending a traffic message to that road user, where the traffic message contains information about the at least one of the at least two road users who cannot send or receive traffic messages;
wherein the determining of road users who can send or receive traffic messages includes an examination of whether the road users can send or receive basic safety messages comprising position and movement information of the road user or collective perception messages which additionally include information from the road user's sensors, and
wherein the sending of the traffic message to at least one road user is performed depending on this examination.

2. The method according to claim 1, wherein if at least one road user cannot send or receive a traffic message, a traffic message containing information about at least one road user is created and sent.

3. The method according to claim 1, wherein if at least one vehicle can send or receive a collective perception message, a collective perception message is created and sent.

4. The method according to claim 1, wherein the determining of road users who can send or receive traffic messages is done by receiving traffic messages of road users.

5. The method according to claim 4, wherein if at least one road user cannot send or receive a traffic message, a traffic message containing information about at least one road user is created and sent.

6. The method according to claim 5, wherein if at least one road user can send or receive a basic safety message, the traffic monitoring system creates and sends a basic safety message containing information about at least one road user who cannot send or receive a traffic message.

7. The method according to claim 5, wherein if at least one vehicle can send or receive a collective perception message, a collective perception message is created and sent.

8. The method according to claim 7, wherein the collective perception message contains only information about road users who cannot send or receive a traffic message.

9. The method according to claim 7, wherein the collective perception message contains only information on road users for whom no basic safety message has been created and sent.

10. The method according to claim 1, wherein the determining of road users includes detection of position as well as movement information.

11. The method according to claim 1, wherein the determining of road users includes the determining of direction of movement, speed or a steering angle.

12. The method according to claim 1, wherein after the traffic messages have been received, it is checked whether the traffic messages contain information on road users which were not detected by the at least one environment sensor and the traffic map is supplemented with this information.

13. A traffic monitoring system for a traffic area with at least one environment sensor for detecting the traffic area and the road users in the traffic area as well as a communication device for sending and receiving traffic messages from road users, wherein the traffic messages may contain status information of the road user or information from the road user's sensors, wherein the traffic monitoring system is configured to carry out a method according to claim 1.

14. The traffic monitoring system according to claim 13, wherein the environment sensor or the communication device are configured to be mobile.

15. The traffic monitoring system according to claim 13, wherein the environment sensor or the communication device are installed on a vehicle or a road user.

16. The traffic monitoring system according to claim 13, wherein the environment sensor or the communication device are installed stationary in or on the traffic area.

17. The traffic monitoring system according to claim 16, wherein the environment sensor or the communication device are configured to be mobile.

18. The traffic monitoring system according to claim 16, wherein the environment sensor or the communication device are installed on a vehicle or a road user.

19. The traffic monitoring system according to claim 13, wherein the environment sensor has an optical, acoustic or electromagnetic sensor.

20. The traffic monitoring system according to claim 13, wherein the environment sensor has a camera, a RADAR or a LIDAR sensor.
